(19) United States
(12) Patent Application Publication
(10) Pub. No.: US 2024/0161135 A1
(43) Pub. Date: May 16, 2024

(54) SYSTEM AND METHOD FOR DATA ANALYSIS, BASED ON MULTIPLE VARIABLES, TO IDENTIFY AND RESOLVE OPERATIONAL ISSUES PERTAINING TO RETAIL STORE

(71) Applicant: Retailigence Ltd., London (GB)

(72) Inventors: Siddhartha Sarangi, Seattle, WA (US); Choudhury Ambika Prasad Das, New Delhi (IN); Phanikrishna Velicheti, Hyderabad (IN)

(21) Appl. No.: 18/055,447

(22) Filed: Nov. 15, 2022

(51) Int. Cl. G06Q 30/0202; G06Q 10/087

(52) U.S. Cl. CPC G06Q 30/0202; G06Q 10/087

(57) ABSTRACT

A method of data analysis by creating a combination of innovative mathematical models for identifying and addressing operational issues at retail stores, by taking into consideration transactional data, customer behavior and other relevant attributes/parameters of items, which helps improve store performance by flagging operational and ranging issues such as detecting underselling and/or missing products in the store. At the central level, the X-Ray Hub provides the information of all the stores of a retailer with the list of products and/or product categories and detects lost sales. At the store level, the X-Ray Mobile application applies the above method and provides results for a particular store which helps the store-staff to take corrective actions. The mobile application uniquely enhances the innovation of the Hub by adding feedback cycles. This helps build a continuous machine learning loop which assists in the learning cycles of both the X-Ray Hub and X-Ray mobile application.

### BACKGROUND

The present system and method relates to data analysis in an unsupervised, unbiased manner by creating a combination of innovative mathematical models, for identifying and addressing operational issues of retailers, by taking into consideration transactional data, customer behavior and other relevant attributes/parameters of items sold in the stores, which helps to improve store performance by detecting underselling products and/or missing products in the store and take corrective action. More specifically, the method relates to optimizing efficiency by using the data in an innovative manner to eliminate hindsight bias and human bias while taking into consideration unlimited variables, including but not limited to customer behavior.

It is exceptionally difficult for large retailers around the globe to constantly identify and resolve operational issues for each and every store in an endeavor to enhance store performance. These issues can stem from several factors, including but not limited to, products missing from the store shelf; products with missing labels, products not positioned properly in the store to be visible to customers, products being dis-arranged et cetera. Owing to such issues, retailers often experience loss of sales or business but find it difficult to identify the reasons for such loss of sales and consequently, fail to take corrective action for the same. Traditionally, store managers carry out store walk-through to personally identify any visible issues, using cameras to capture pictures/videos for the same. However, all these methods depend heavily on the efficiency of certain individuals at the store and thus, cannot be uniform across all stores of a retailer. The said method of identifying operational issues also often results in inaccurate results and consequently, inadequate, and inefficient solutions.

Some prior art techniques use a device to capture images in the stores and compare them with a pre-defined list of item images to identify issues. This method is prone to human errors as the coverage is based on human intervention only. Thus, this method only identifies issues with respect to a pre-defined list for the store.

Certain prior art techniques require a combination of various electronic devices to be installed in the store, like weight sensors, proximity sensors, 3d cameras, microphones, RFID tags, NFC, electronic printed tags, LED sensors, optical sensors, IOT sensors et cetera to identify Many prior art techniques work on product related parameters such as sales of the product, cost of the product, stored amount of product, number of ordered amounts of product, profit on the product, predicted sales of the product, to identify relationship between products and potential issues. This method is highly biased as it is based only on the parameters used for determining the aforesaid relationship and does not consider other pertinent influencing factors.

In case any one component is not configured properly, the results will be prone to errors and influenced by the configuration of the sensors. This also requires significant hardware installation and maintenance overheads leading to retailers rejecting them.

Therefore, retailers need to analyze customers' behavior along with all other relevant attributes/parameters (ex. brand of the product, product categories, product distance, product characteristics, customer buying behavior et cetera). The present system and method efficiently identifies such operational issues by analyzing data based on actual sales and transactions, which is updated every week and consequently, predicts loss of business for a retailer and quantifies the value of the lost opportunity for each store, each product group and each individual product, which helps the retail stores to prioritize their actions.

This method can be applied to a system both at a macro level i.e. central level for all stores of a retailer and/or at micro level i.e. store level by providing the list of products with and the quantified value of missing sales and/or under sales. In order to facilitate the process at central level, the X-Ray Hub provides the information of all the stores of a retailer with the list of products and/or product categories and predict and detect lost sales. In order to facilitate the process at store level, the X-Ray Mobile application applies the above method and provides results for a particular store of a retailer which helps the store staff to take corrective action. This method, at the store level, enables the user/store staff to investigate the reason for missing sales and/or under sales of certain products or category of products in its store(s), feed such reason on the X-Ray mobile application and accordingly, take action to resolve the issue. The specific reason and the actions taken are also captured through the X-Ray mobile application. While the X-Ray hub is unparalleled in the market, it is supplemented by the X-Ray mobile application. The X-Ray mobile application uniquely enhances the innovation of the X-Ray Hub by adding a feedback cycle. This is unique because the Hub and the mobile application work complementary to each other. This helps to build a machine learning loop which assists in the learning cycles of both the X-Ray Hub and X-Ray mobile application.

In embodiments of the present invention, a method is provided for an unsupervised, unbiased process of analyzing data by creating a combination of innovative mathematical models, which consider the customers' buying behavior within each store for particular products along with other relevant attributes of the store, item, proportions, core items et cetera to create store clusters and generate a recommended list of items along with the quantified lost sales value.

### BRIEF DESCRIPTION OF THE DRAWINGS

The features and advantages of the present disclosure will be more clearly understood with reference to the following detailed description when taken in conjunction with the accompanying figures, wherein:

FIG. 1 explains the complete method along with the input data sources/types and the final output.

FIG. 2 is a block diagram and explains the data preparation process of the method.

FIG. 3 is a block diagram and explains the machine learning algorithm pass process of the method.

FIG. 4 explains the core item analysis process of the method.

FIG. 5 explains the recommendation analysis and the cluster Item analysis process of the method.

FIG. 6 explains about the sales interpolation.

FIG. 7 explains about the machine learning algorithm for reasoning.

FIG. 8 explains about the learning model pass to predict reasoning including false positive.

### SUMMARY

In view of the foregoing and in accordance with the present method, consisting of various steps and processes including the way the data is being used, processing the data through various mathematical/statistical modeling and ways of interpreting and analysis, and establishing the underlying patterns is provided. During this process, the present method uses and takes advantage of past transactional data by using them in an innovative way in different steps and processes. This is implemented using the machine learning mechanisms at the central level and the store level in order to achieve the desired results.

### DETAILED DESCRIPTION

In embodiments of the present invention, a method is described for collecting and processing a store's transaction data for a retailer in an unsupervised and unbiased manner, by integrating various machine learning algorithms to generate store clusters.

Once store clusters are created, various aspects of the data across clusters are projected to provide an understanding of each cluster as well as the differences between the clusters. These projections are calculated, and the output is generated to include different dimensions namely store attributes, product attributes, demographic attributes, sales channel attributes. It is pertinent to mention that such store clusters are created on a product group level which enable the retailer to identify out-of-sync products.

Once such out-of-sync products are identified, the method flags ranging and operational issues causing such products or items to be undersold. The system and method monitors a retailers' assortments, clusters and performance in stores and enables them to take corrective action.

This method of data analysis also helps the store staff to identify the reason for lost sales, take corrective action and avoid lost sales. Once a retailer feeds sufficient data in the X-Ray mobile application vis-à-vis reasons for lost sales and corrective actions, the method processes this data as well and suggests the potential reasons for lost sales next time and recommends most probable ways to take corrective action.

The present system and method saves time, money, and resources for retailers because after the creation and analysis of store clusters, and identification of out-of-sync products, the retailer has a clear picture of the root cause of their lost sales and the corrective measures needed to avoid and/or rectify the same. Consequently, this method enables retailers to determine which products should be included or excluded from their range of products based on potential operational and assortment issues at their store(s). Thus, it is not a trial and error method resulting in wastage of time and resources of the retailer to achieve the desired efficiency and performance.

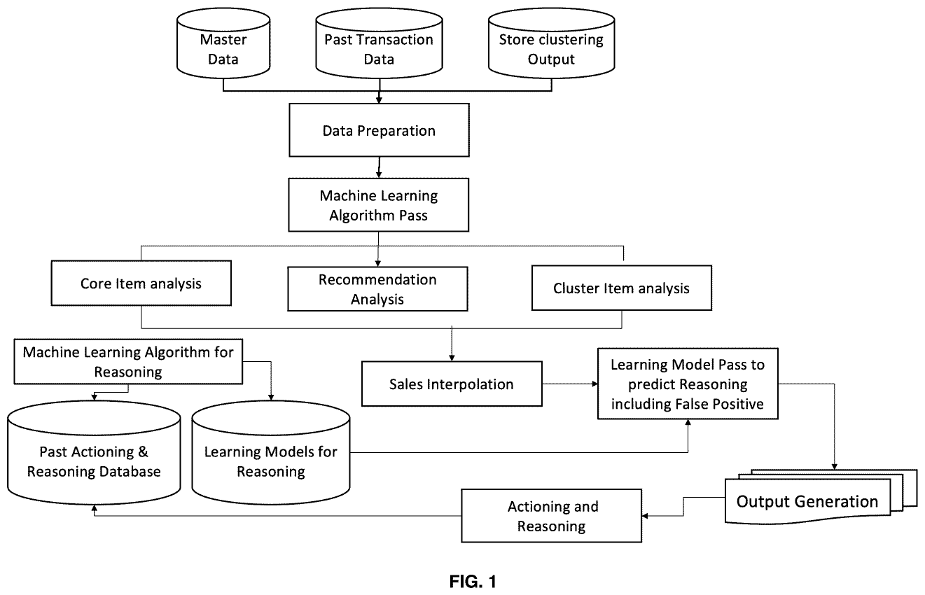

FIG. 1 displays a high level over view of a process according to an embodiment of the invention.

Master Data—This includes the master data namely the information of all the stores and their attributes/parameters, all the products which are traded by the retailer across all stores and their attributes/parameters including the product hierarchy and grouping information.

The store information includes but is not limited to identification code, physical location, size in terms of area. The process is designed to take into consideration all available parameters or attributes of stores, regardless of the nature of business.

The product information includes but is not limited to identification code, product hierarchy, available attributes such as brand of the product, product categories, product distance, product characteristics et cetera. The process is designed to take into consideration all available parameters or attributes of products.

Past Transaction Data—This includes the data of all sales transactions for each store and product combination. This can be at an individual transaction level or summarized for different time periods. It also includes other attributes/parameters of the transactions apart from the units sold, value sold, such as sales channel(s), customer attribute(s).

Store Clustering Output—This includes a cluster identification number with respect to each store for a particular group of products. The cluster identification number or grouping can be different for different group of products. This represents grouping of stores for different group of products. Reference is made to U.S. patent application Ser. No. 17/822,540, filed by the applicant herein on Aug. 26, 2022 for its unbiased method of creating store clusters based on multiple variables and customer behavior.

Data Preparation—This process is unique in terms of how the previous transaction data is prepared for further analysis. The input data are summarized, outlier datasets are identified using statistical methods and removed to avoid any biasing in the further analysis, all the data is then normalized. Finally, a mathematical vector is generated for each store across all items, which represents each and every store in a mathematical vector form.

Machine Learning Algorithm Pass—This process takes the input from the output of the data preparation step. It takes each item represented by a vector and create a statistical matrix for all the items to identify the closeness or correlation of each item with all others for the whole business for each of the store clusters and product group combination. Through this process, all influencing factors are considered and evaluated, including customer buying behavior, without any human intervention and biasing.

Core Item Analysis—This process takes the input as past transaction data to find the top contributing products based on value sold in each store cluster. The core items list is used in recommendation analysis.

Recommendation Analysis—Once all core items are created in each store cluster, this process takes input of the machine learning algorithm pass and gets a recommended item for each core item at each store.

Cluster Item Analysis—This process helps to calculate the average proportion value of the recommended item in a cluster, which is then used to get the proportional value of the recommended products for each store.

Sales Interpolation—This process takes the output of recommendation analysis and cluster item analysis to calculate missing (lost) sales and under sales for each recommended item of each store.

[Machine Learning Algorithm for Reasoning—This process is a machine learning process to create a learning model to learn from the previous list of recommendation of lost sales for each store and the reasons and/or actions associated with them. The output of this process is used to further optimize the recommended list of products.

Machine Learning Pass to predict reasoning including false positive—This process uses the recommended list for each store and the learning model of the reasoning to further optimize the list of recommended products either to remove potential product recommendations, which may be false positive and/or to predict the potential reason for the underperformance of such product at a store.

Actioning and Reasoning—This process is facilitated with the system X-Ray mobile application, where in the store users go through the list of recommended under-performing products and provide reasons and actions taken in the store for such items as corrective measures. This information is accumulated and used for the Machine Learning Algorithm for Reasoning.

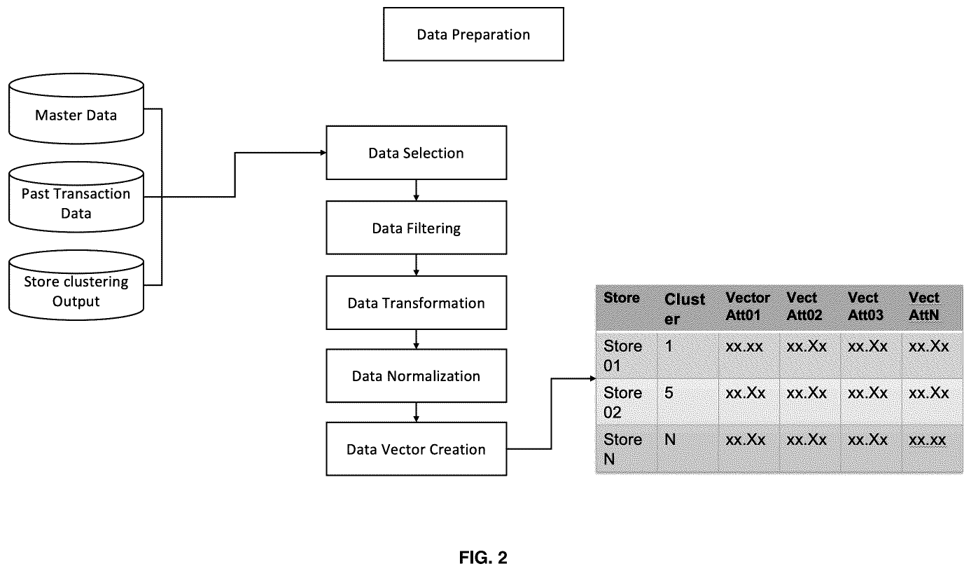

FIG. 2 displays a data preparation process according to an embodiment of the invention.

Data Selection—This includes selection of the data based on the analysis window in terms of calendar dates from the past transaction data, attributes of the store and item information from the master data source, and other attributes from the external data source as provided.

Data Filtering—Considering that the data may have outliers within it, the filtering process helps to remove the bottom and top outliers based on statistical threshold parameters in the model to remove any data biasing based on certain data points, which may not be relevant.

Data Transformation—This process takes care of transforming the data after filtering, by selecting the data points that are relevant for the analysis and summarizing the data for every store and every item for the relevant data points.

Data Normalization—This process normalizes the data after transformation, to make sure that for every store, the total sum of all values for items sum up to 100% as contribution, which creates the contribution matrix for each store and item combination. This process helps in removing potential bias that may be caused due to different size of the stores and it considers customer buying behavior as the primary influencing factor.

Data Vector Creation—This process creates a mathematical vector from the normalized data for each store, which is used for further analysis.

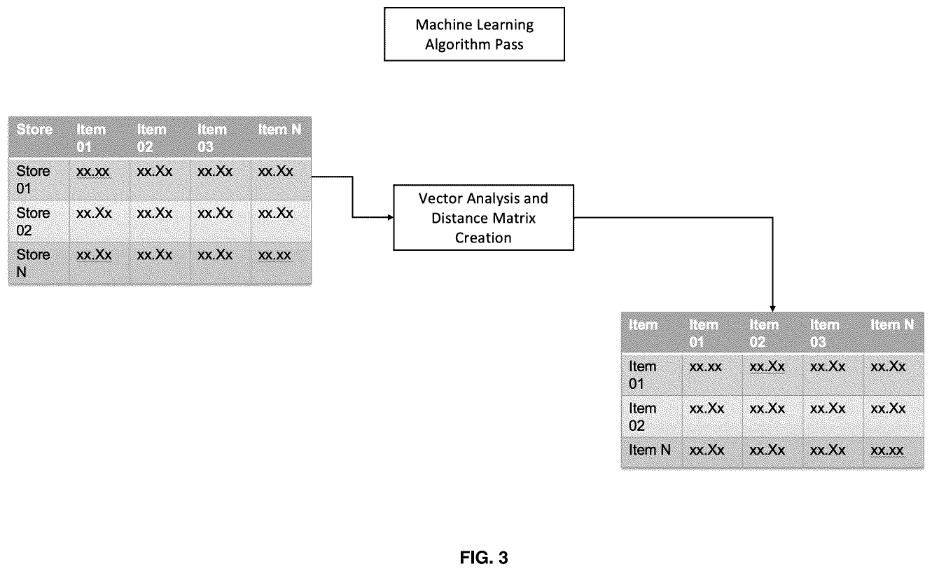

FIG. 3 displays a machine learning algorithm pass process according to an embodiment of the invention.

Vector Analysis and Correlation Matrix Creation—This process takes the mathematical vector created for each store and item combination and creates another matrix, which is a matrix consisting of items both in rows and columns. It then calculates the correlated distance of each item from other and updates the item-to-item matrix. This process is done for each store cluster.

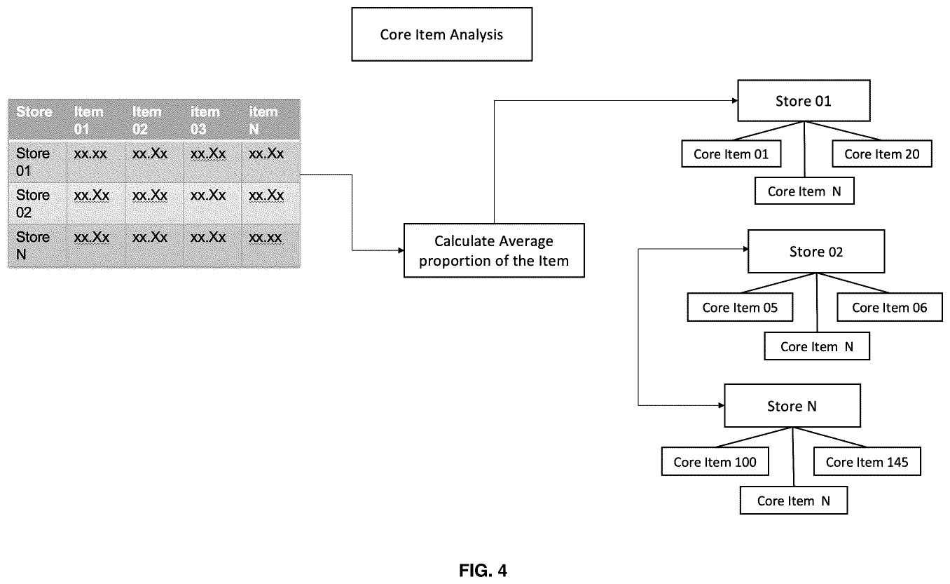

FIG. 4. Displays a core item analysis process according to an embodiment of the invention.

Calculate Cumulative Proportion of Item—This step finds the cumulative proportion of the item for each store and then filters the cumulative proportion list by using statistically derived threshold value of the correlation. The filtered items are then considered as the top core items for a particular store.

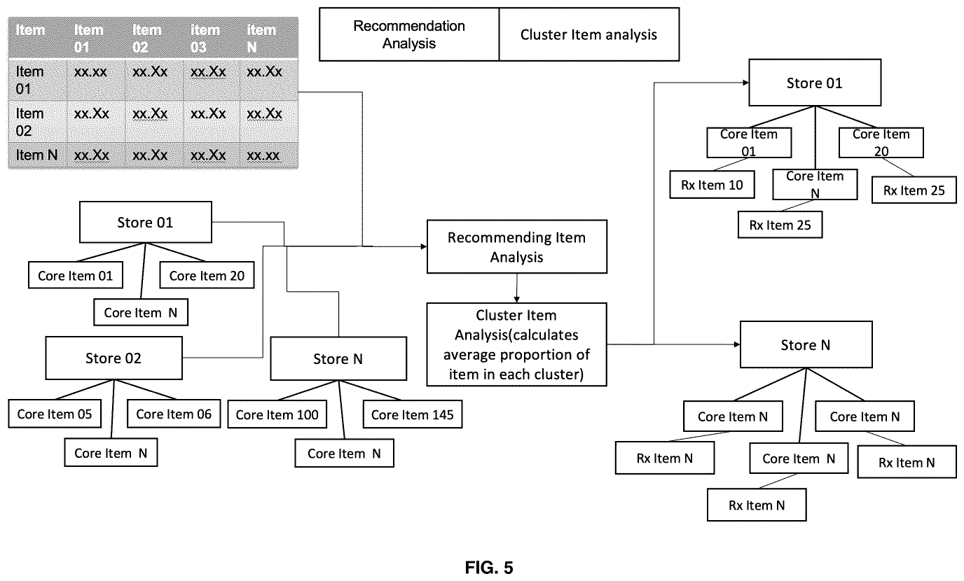

FIG. 5 displays a recommendation analysis and cluster item analysis process according to an embodiment of the invention.

Recommending Item Analysis—This step uses the Vector Analysis, Correlation Matrix output and Core Item analysis output to get the list of recommended items for each core item for each store. All the recommended items are then grouped together for each store for generating the store recommended list of underperforming items.

Cluster Item Analysis (Calculates Average Proportion of Item in each Cluster)—This step calculates the sales proportion of items within each store cluster. It also applies a filter on the proportion value using a derived statistical threshold, which helps to determine a prospective list of recommendation items for a particular cluster along with its proportion for each store for each store cluster.

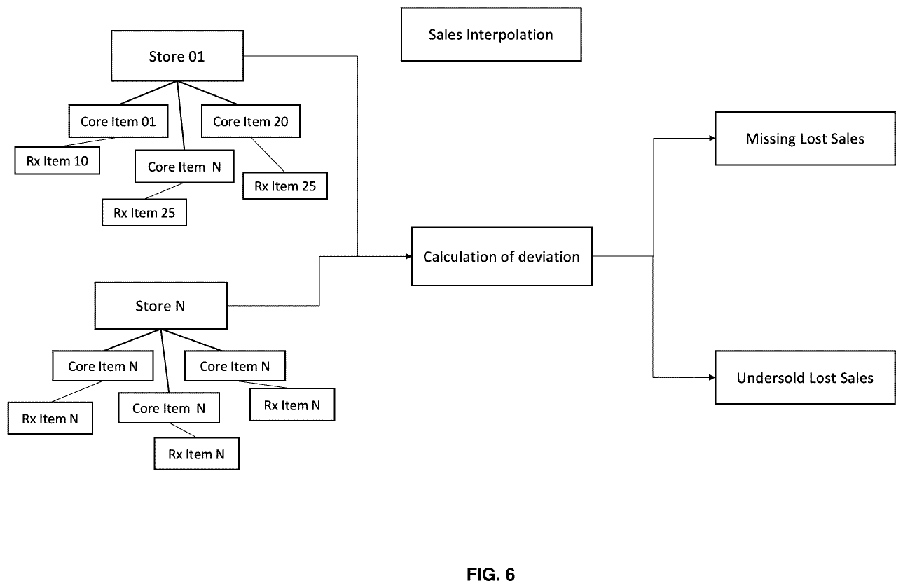

FIG. 6 displays a sales interpolation process according to an embodiment of the invention.

Calculation of Deviation—For every recommended item for each store, based on the actual sales for the selected period, the proportion of the item in the store is compared to the proportion for the store cluster. The difference between these two are considered for quantifying the lost sales value of the underperforming items in each of the stores. The positive deviations are filtered for consideration. Recommended item is flagged as undersold item or missing item based on sale value of that item in that store along with the lost sale value, which is considered as the sale opportunity of underperformance.

Lost Sales—The quantified deviated value from the above step is multiplied with the total sales of the store for each recommended item. For undersold items, the lost sale is the difference between the quantified sales minus the actual sales, whereas for missing items, the lost sale is the quantified sales alone.

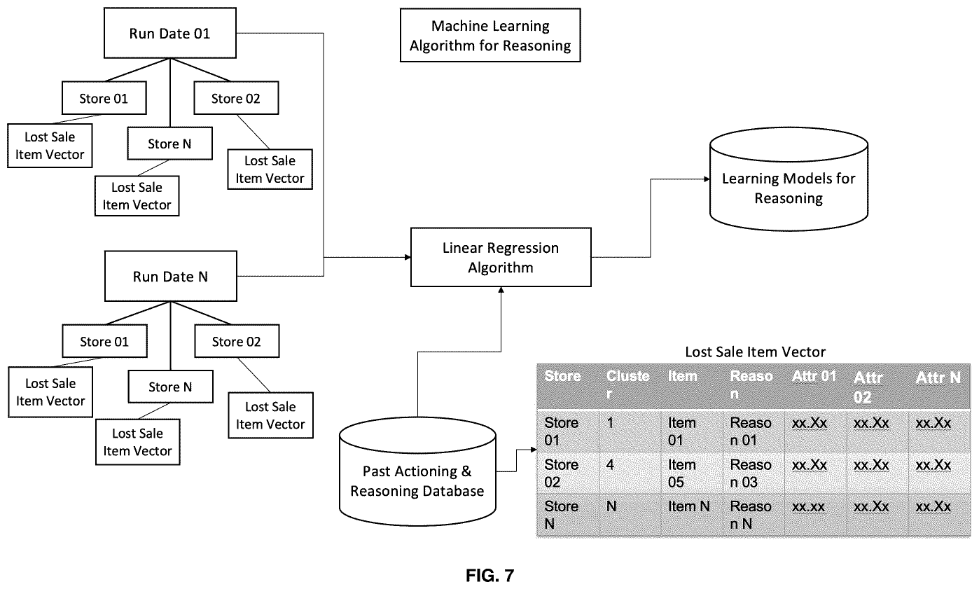

FIG. 7 displays a machine learning algorithm for reasoning process according to an embodiment of the invention.

Past Actions and Reasoning Database—The invention includes a system mobile application for the store personnel to view the recommended list of items, which are under performing and have potential operational issues at the store. The store personnel then update the reasons identified at the store (including false positives and no operational issues) along with any actions that may have been taken. This information is updated and stored in the past reasoning and reasoning database every week along with the recommendation details.

Linear Regression Algorithm—Based on the Past Actioning and Reasoning database and the recommended list of items along with the quantified lost sales value and other attributes of the store, item, proportions, core items et cetera, a mathematical vector is created for each store and item combination for each week and then combined as a large mathematical vector, with the output value of that vector as the specific reason along with actions (if available) for each store and item combination. This mathematical vector is then used as learning dataset and processed through a linear regression model. The output of this model is stored as the Learning Model for Reasoning and Actioning.

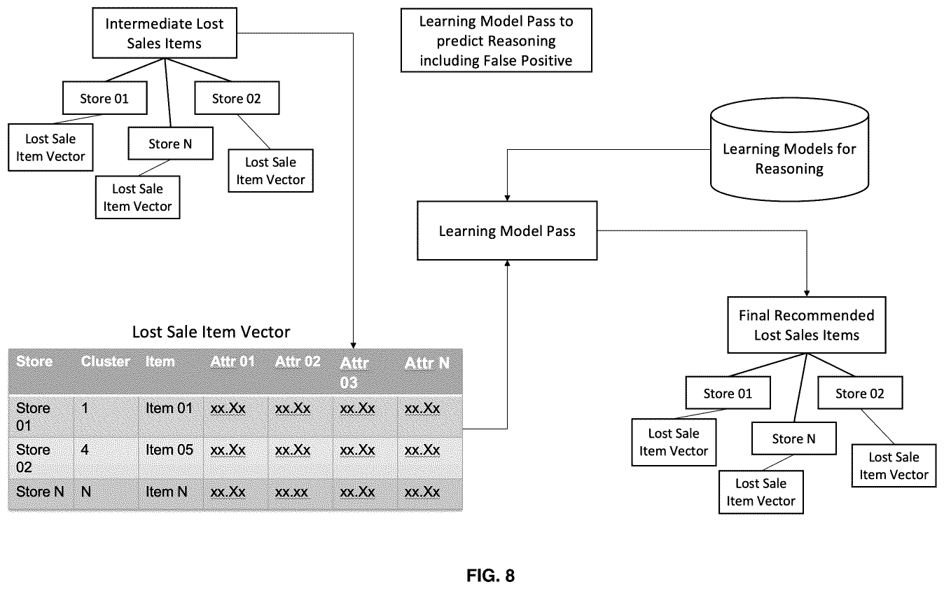

FIG. 8 displays a learning model pass to predict reasoning including false positive process according to an embodiment of the invention.

Learning Model Pass—The recommended item list from the previous process steps and the Learning Models for Reasoning are considered as inputs for this process. This process creates a mathematical vector for each recommended store item combination along with all the attributes or variables, that were considered for the Machine Learning Algorithm Process and then reason predictions for each of the recommended item for each store is generated using the Learning Model Database. The predicted reasons are then filtered with a statistically derived threshold for confidence, anything below the threshold value, the reason prediction is removed. In case the reason prediction is a false positive, then the item recommendation for the store is removed from the final recommended list.

We claim:

1. A computer implemented method of unbiased data analysis comprising:
providing a data set on a weekly basis;
applying a machine learning algorithm pass to the data set;
performing a core item analysis on the data set;
performing a recommendation analysis on the data set;
performing a cluster item analysis on the data set;
performing a sales interpolation on the data set;
applying machine learning algorithm for reasoning to the data set;
applying machine learning pass to predict reasoning, including false positive, to the data set;
applying actioning and reasoning to the data set;
generating an output.

2. The method of claim 1, further comprising the step of:
providing an artificial intelligence platform that is configured to establish underlying patterns in the data set: (a) analyzing data from past transactions; (b) creating store clusters; (c) creating a mathematical vector of each store and item combination; (c) processing the data through a mathematical/statistical model; and establishing the underlying patterns in the data set.

3. A method as in claim 1, further comprising the step of:
creating a core item list and recommended item list by taking inputs and data from a machine learning algorithm and analyzing unlimited variables in an unbiased manner, such as the distance/similarity between products; customer buying behavior, including but not limited to season, time of the year; sales of product(s) at each store; sales of product(s) in each store cluster (group of similar stores); positioning of products in a store et cetera.

4. A method as in claim 1 further comprising the step of:
calculating the average proportion value of the recommended item in a cluster, which is then used to get the proportional value of the recommended products for each store and using this data to calculate missing (lost) sales and under sales for each recommended item of each store.

5. A method as in claim 4 in which a learning model is created to learn from the previous list of recommendation of lost sales for each store and the potential reasons associated with such lost sales. The output of this process is used to further optimize the recommended list of products.

6. A computer implemented method as in claim 5 further comprising the step of:
predicting loss of sales and business for a retailer and quantification of the value of the lost opportunity for each store, each product group and each individual product, which helps the retail stores to determine which products should be included or excluded from their range of products.

7. A method as in claim 1 flags ranging and operational issues at a retail store such as confusing displays, out of stock products, incorrect ticketing and missing range, and prevents lost sales by suggesting likely reasons for such issues such as display issue, empty shelf, price discrepancy, missing promotional ticket, insufficient space et cetera.

8. A computer implemented method as in claim 7 further comprising the step of:
enabling a system for the users at a central level namely the X-ray Hub to predict as well as quantify lost sales and business and the potential reasons thereof for all stores of a retailer, and also a system at a store level namely the X-ray mobile application, to predict as well as quantify lost sales and business of a particular store, prioritize actions and investigate the actual reason for missing sales and/or under sales of certain products or category of products in its store(s), feed such reason on the system of X-Ray mobile application and accordingly, take action to resolve the issue.
